(19) United States
(12) Patent Application Publication
(10) Pub. No.: US 2020/0354859 A1
(43) Pub. Date: Nov. 12, 2020

(54) CONTROLLED ATMOSPHERE RECIRCULATION OVEN

(71) Applicant: FURNACE ENGINEERING PTY LTD, Notting Hill, Victoria (AU)

(72) Inventors: Brian Philip Gooden, Notting Hill, Victoria (AU); Peter Newman, Notting Hill, Victoria (AU)

(21) Appl. No.: 16/760,812

(22) PCT Filed: Nov. 1, 2018
(86) PCT No.: PCT/AU2018/051184

§ 371 Date: Apr. 30, 2020

Related U.S. Application Data
(60) Provisional application No. 62/580,888, filed on Nov. 2, 2017.

(51) Int. Cl. D01F 9/32; D01D 10/02; D01F 9/22; F27B 9/28; F27B 9/20; F27B 9/04; F27B 9/06; F27D 11/00; F27D 7/04; F27D 13/00; F27B 9/40; F27B 9/08

(52) U.S. Cl. CPC D01F 9/32; D01D 10/02; D01F 9/22; F27B 9/28; F27B 9/20; F27B 9/045; F27B 2009/3033; F27D 11/00; F27D 7/04; F27D 13/00; F27B 9/40; F27B 9/084; F27D 2007/045; F27B 9/062

(57) ABSTRACT

An apparatus useful in treating a carbon fibre precursor material under predetermined conditions of temperature and gaseous environment. The apparatus includes a housing, and a reaction chamber disposed within the housing. The reaction chamber is elongate and has an entry port at a first end and an exit port at a second end. The entry and exit ports are configured to allow passage of a carbon fibre precursor material into and out of the reaction chamber respectively. A heater or heating system is configured to heat a wall of the reaction chamber. In use, a precursor material is passed through the reaction chamber and is thereby heated.

### FIELD OF THE INVENTION

The present invention is directed to apparatus useful, for example, in the production of carbon fibre. In particular, the invention is directed to an apparatus useful in treating a carbon fibre precursor material under predetermined conditions of temperature and gaseous environment.

### BACKGROUND OF THE INVENTION

In many manufacturing processes it is necessary to heat a precursor under controlled atmospheric conditions. For example, carbon fibre is produced by pyrolysis of a precursor fibre in a controlled atmosphere at elevated temperatures. Carbonization occurs in an ideally oxygen-free atmosphere inside a series of furnaces that progressively increase the processing temperatures. Typically, two types of continuous processing furnaces are required in the process: LT (low temperature, typically around 1000° C.), HT (high temperature, typically around 1600° C.). On some occasions, UHT (ultrahigh temperature, in excess of 1800° C.) furnaces are required.

For some manufacturing processes it is critical that a precursor is heated uniformly within an oven. This end is often achieved by establishing high mass flow of a heated process gas through the oven. However, uniformity of heating may be difficult to achieve where gas flow velocities are necessarily low such as in some steps of carbon fibre manufacture. This difficulty is compounded for ovens used in carbon fibre manufacturing which are prone to temperature variations along their long process paths. Carbon fibre ovens also require open entry and exit ports given the need for continuous processing of precursors, these ports adding further to temperature variations given the propensity for gases of varying temperatures to pass therethrough.

In carbon fibre manufacture, tight control of process temperature is desirable to improve yields. Temperature excursions can in some instances even lead to uncontrolled combustion of carbon fibre precursor

The present invention is directed in one aspect to apparatus for improving the uniformity of heat distribution in an oven, and particularly an oven used in the treatment of carbon fibre precursors such as PAN and other materials. In another aspect, the invention is directed to a useful alternative to prior art ovens.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, the present invention provides an apparatus for treating a carbon fibre precursor material, the apparatus comprising: a housing, and a reaction chamber disposed within the housing, the reaction chamber being elongate and having an entry port at a first end and an exit port at a second end, the entry and exit ports configured to allow passage of a carbon fibre precursor material into and out of the reaction chamber respectively and a heater or heating system configured to heat a wall of the reaction chamber, wherein, in use, a precursor material is passed through the reaction chamber and is thereby heated.

In one embodiment of the first aspect or any other aspect, the heater or heating system is disposed partially or completely external to the reaction chamber, partially internal to the reaction chamber, or partially or completely within a wall of the reaction chamber, or completely internal to the reaction chamber where another heater or another part of the heating system is disposed partially or completely external to the reaction chamber.

In one embodiment of the first aspect or any other aspect, the housing is substantially thermally insulated.

In one embodiment of the first aspect or any other aspect, the reaction chamber is suspended or supported within the housing such that the reaction chamber does not contact a floor or a ceiling of the reaction chamber.

In one embodiment of the first aspect or any other aspect, the reaction chamber is a muffle.

In one embodiment of the first aspect or any other aspect the apparatus comprises: a process gas source in fluid communication with the interior of the reaction chamber, and a process gas recirculation means configured to recirculate the process gas within the interior of the reaction chamber, wherein, in use, a carbon fibre precursor material is passed through the reaction chamber and the process gas recirculation means causes a substantially laminar flow of a heated process gas to contact the carbon fibre precursor material, and the heater or heating system heater or heating system regulates or stabilises the temperature of the process gas within the reaction chamber.

In one embodiment of the first aspect or any other aspect, the heater or heating system is a heated gas in contact with one or more external surfaces of the reaction chamber.

In one embodiment of the first aspect or any other aspect, the apparatus comprises a heated gas heating means.

In one embodiment of the first aspect or any other aspect, the housing is configured to retain a heated gas about one or more external surfaces of the reaction chamber.

In one embodiment of the first aspect or any other aspect, the heater or heating system comprises one or more electrical heating elements.

In one embodiment of the first aspect or any other aspect, the heater or heating system comprises one or more paired electrical heating elements wherein, (i) one of the one or more paired electrical heating elements disposed above an upper surface of the reaction chamber and the other of the one or more paired electrical heating element disposed below a lower surface of the reaction chamber, and/or (ii) one of the one or more paired electrical heating elements disposed lateral to a side surface of the reaction chamber and the other of the one or more paired electrical heating element disposed lateral to the opposing side surface of the reaction chamber.

In one embodiment of the first aspect or any other aspect, wherein the heater or heating system comprises a series of electrical heating elements disposed at intervals along the length of the apparatus.

In one embodiment of the first aspect or any other aspect, the apparatus comprises heated gas stirring or recirculation means configured to stir or circulate a heated gas in contact with one or more external surfaces of the reaction chamber.

In one embodiment of the first aspect or any other aspect, the heater or heating system comprises one or more paired heated gas stirring or recirculation means wherein, (i) one of the one or more paired heated gas stirring or recirculation means disposed above an upper surface of the reaction chamber and the other of the one or more heated gas stirring or recirculation means disposed below a lower surface of the reaction chamber, and/or (ii) one of the one or more paired heating gas stirring or recirculation means disposed lateral to a side surface of the reaction chamber and the other of the one or more paired heating gas stirring or recirculation means disposed lateral to the opposing side surface of the reaction chamber.

In one embodiment of the first aspect or any other aspect, the heater or heating system comprises a series of heated gas stirring or recirculation means disposed at intervals along the length of the apparatus.

In one embodiment of the first aspect or any other aspect, the heated gas stirring or recirculation means is a fan.

In one embodiment of the first aspect or any other aspect, the heater or heater system is disposed proximal to the heated gas stirring or recirculation means.

In one embodiment of the first aspect or any other aspect, the heated gas stirring or recirculation means is straddled by a pair of the heated gas stirring or recirculation means.

In one embodiment of the first aspect or any other aspect, the apparatus is configured such that the process gas is recirculated in opposing centre-to-end recirculation paths or an end-to-end recirculation path.

In one embodiment of the first aspect or any other aspect, the process gas recirculation means comprise one or more fans configured to direct the process gas in a direction generally along the length of reaction chamber

In one embodiment of the first aspect or any other aspect, the process gas recirculation means comprises a centrifugal fan.

In one embodiment of the first aspect or any other aspect, the centrifugal fan is disposed at or toward the end of a centre-to-end recirculation system, or at or toward the end of an end-to-end recirculation system.

In one embodiment of the first aspect or any other aspect, the apparatus comprises process gas injection means configured to inject a process gas to the interior of the reaction chamber, wherein the process gas injection means is configured to inject the process gas at or about the process gas recirculation means.

In one embodiment of the first aspect or any other aspect, the apparatus comprises a divider, the divider being disposed within the reaction chamber and running along the length thereof, so as to at least partially separate process gas in a return gas flow path from a main gas flow path.

In one embodiment of the first aspect or any other aspect, the divider is part of a discrete duct, or forms a duct in combination with one or more interior surfaces of the reaction chamber.

In one embodiment of the first aspect or any other aspect, the apparatus comprises heating means configured to heat a process gas before introduction into the reaction chamber.

In one embodiment of the first aspect or any other aspect, the apparatus comprises a pre-heater or having an associated pre-heater, the pre-heater being configured to increase the temperature of a material that is destined to enter the reaction chamber.

In one embodiment of the first aspect or any other aspect, the apparatus comprises means for dividing the heated gas retained about the one or more external surfaces of the reaction chamber into two or more zones, wherein the apparatus is operable such that the temperature of a heated gas in a first zone is different to the temperature of a heated gas in a second zone.

In one embodiment of the first aspect or any other aspect the means for dividing the heated gas retained about the one or more external surfaces of the reaction chamber into two or more zones is a divider or a partial divider.

In one embodiment of the first aspect or any other aspect the housing comprises venting means configured to alternate from a closed form to an open form, wherein in the closed form the venting means inhibits or prevents exchange of gas between the environment external the housing and the environment internal the housing, and in the open form the venting means allows or facilitates the exchange of gas between the environment external the housing and the environment internal the housing.

In one embodiment of the first aspect or any other aspect, the process gas is a substantially non-oxidizing gas selected from, but not limited to any Group 18 gas of the Periodic Table (such as helium, neon or argon), carbon dioxide, hydrogen, and nitrogen

In one embodiment of the first aspect or any other aspect, the entry port and/or exit port is a slot.

In one embodiment of the first aspect or any other aspect, the entry and or/exit port comprise adjustable choke(s) and/or baffle(s).

In one embodiment of the first aspect or any other aspect, the choke comprises two sliding plates with each plate sliding independently of the other such that the position of a slot formed between the two plates may be altered.

In one embodiment of the first aspect or any other aspect, the apparatus comprises a gas curtain about the entry port and/or exit port, the gas curtain having gas flow characteristics adapted to exclude atmospheric oxygen from the reaction chamber.

In one embodiment of the first aspect or any other aspect, the gas curtain has gas flow characteristics adapted to disrupt atmospheric oxygen bound to a carbon fibre precursor material passing through the gas curtain.

In one embodiment of the first aspect or any other aspect, the gas curtain comprises two regions: the first region having gas flow characteristics adapted to avoid the ingress of atmospheric oxygen into the reaction chamber, the second region having gas flow characteristics adapted to disrupt and displace atmospheric oxygen on a carbon fibre precursor material passing through the gas curtain.

In one embodiment of the first aspect or any other aspect, the apparatus comprises an exhaust system configured to extract an exhaust gas from the reaction chamber.

In one embodiment of the first aspect or any other aspect, the gas curtain comprises a marker gas source adapted to dispense a marker gas about the entry and/or exit port(s), temperature measuring means disposed at location(s) allowing for detection of mixing of the marker gas with the process gas by reference to the temperature of the mixed marker and process gasses,

In one embodiment of the first aspect or any other aspect, the apparatus is configured such that in use the marker gas is warmer or colder than the process gas, and (i) when atmospheric oxygen is being drawn into the reaction chamber via the entry or exit port the process gas is mixed with and warmed or cooled by the marker gas, and/or (ii) when exhaust gases are escaping via the entry or exit port the marker gas is mixed with and warmed or cooled by the process gas, situations (i) and (ii) being discernible by analysis of the temperature reading(s).

In one embodiment of the first aspect or any other aspect, the apparatus comprises a carbon fibre precursor material transport means configured to transport a length of carbon fibre precursor material from the entry port to the exit port of the reaction chamber.

In one embodiment of the first aspect or any other aspect, the carbon fibre precursor material transport means comprises a roller.

The apparatus of any embodiment of the present invention may be useful for in a method for the production of many types of product, the method being dependent on the precise regulation of process temperature, and optionally also dependent on the provision of a controlled gaseous environment. An exemplary method is a method for production of carbon fibre, whereby a precursor (such as PAN) is passed through an apparatus according to the present invention. An exemplary method is that disclosed in U.S. Pat. No. 5,256,344 (to Hercules Incorporated); the contents of which is herein incorporated by reference.

The apparatus of any embodiment of the present invention may be useful as a component of a system for the production of many types of product, the system being dependent on the precise regulation of process temperature, and optionally also dependent on the provision of a controlled gaseous environment. An exemplary system is that disclosed in U.S. Pat. No. 5,256,344. Other system components may include an oxidation apparatus or a carbonization apparatus.

### BRIEF DESCRIPTION OF THE FIGURES

FIG. 1A is a highly diagrammatic drawing in cross-sectional lateral view of a preferred apparatus of the present invention. This embodiment comprises a gas curtain device at each end. A centre-to-end gas recirculation is used.

FIG. 1B is a highly diagrammatic drawing in cut-way plan view of the preferred apparatus of FIG. 1A. Components are marked consistently with those of FIG. 1A.

FIG. 1C is a highly diagrammatic drawing in cross-sectional end-on view of the preferred apparatus of FIG. 1A. Components are marked consistently with those of FIG. 1A.

FIG. 2A is a highly diagrammatic drawing in cross-sectional lateral view of a preferred apparatus of the present invention that is similar to that of FIG. 1A, but using an end-to-end gas recirculation system. Shared components are marked consistently with those of FIG. 1A.

FIG. 2B is a highly diagrammatic drawing in cut-way plan view of the preferred apparatus of FIG. 2A. Shared components are marked consistently with those of FIG. 1B.

FIG. 2C is a highly diagrammatic drawing in plan view of a preferred apparatus that is similar to that shown in FIGS. 2A and 2B, but using a product cooler disposed before the exit curtain, and a preheater disposed after the entry curtain to preheat incoming material.

FIG. 2D is a highly diagrammatic drawing showing a cross-sectional lateral view of the preferred apparatus shown in FIG. 2C.

### DETAILED DESCRIPTION OF THE INVENTION

After considering this description it will be apparent to one skilled in the art how the invention is implemented in various alternative embodiments and alternative applications. However, although various embodiments of the present invention will be described herein, it is understood that these embodiments are presented by way of example only, and not limitation. As such, this description of various alternative embodiments should not be construed to limit the scope or breadth of the present invention. Furthermore, statements of advantages or other aspects apply to specific exemplary embodiments, and not necessarily to all embodiments covered by the claims.

Throughout the description and the claims of this specification the word “comprise” and variations of the word, such as “comprising” and “comprises” is not intended to exclude other additives, components, integers or steps.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may.

It will be understood that while certain advantages of the invention are described herein it is not represented that all embodiments of the invention will possess all advantages. Some embodiments of the invention may provide no advantage whatsoever and may represent no more than an alternative to the prior art.

The present invention is predicated at least in part on Applicant's finding that temperature variations can be limited by the use of an oven having a controlled atmosphere reaction chamber that is surrounded by means for heating a gas surrounding the reaction chamber. In addition or alternatively, the controlled atmosphere reaction chamber has means for heating gas inside the chamber. Without wishing to be limited by theory in any way, Applicant proposes that some steps in the carbon fibre manufacture processes (and particularly those that preclude the use of a process gas at high velocity) are particularly temperature sensitive and yields may be improved using an oven having a discrete reaction chamber (such as a muffle) within the oven with associated heating means.

Thus, use of ovens of the present invention may allow for the extent of temperature sensitive chemical reaction(s) to be finely controlled. In carbon fibre manufacture, temperature of precursor may be maintained within strict limits for the length of the fibre path through the oven. Accordingly, in a first aspect the present invention provides an apparatus for treating a carbon fibre precursor, the apparatus comprising: a reaction chamber which is elongate and having an entry port at a first end and an exit port at a second end, the entry and exit ports configured to allow passage of a carbon fibre precursor into and out of the reaction chamber respectively, a process gas source in fluid communication with the interior of the reaction chamber, a process gas recirculation means configured to recirculate the process gas within the interior of the reaction chamber, and a heater or heating system configured to heat the reaction chamber via the external surfaces of the reaction chamber, wherein, in use, a carbon fibre precursor is passed through the reaction chamber and the process gas recirculation means causes a substantially laminar flow of a heated process gas to contact the carbon fibre precursor, and the heater or heating system regulates or stabilises the temperature of the process gas within the reaction chamber.

It is proposed that the use of a heated gas (such as heated air) about the reaction chamber provides a more even temperature on the external surface of the chamber thereby more evenly heating the interior of the reaction chamber along its length, even where process gas contacting with the precursor is recirculated at relatively low velocities. The precursor fibre within the reaction chamber is therefore evenly heated along its length so as to provide predictability in the extent of a desired chemical reaction for any given length of precursor fibre. Further disclosure relating to the means for heating the gas retained about the reaction vessel will be discussed further elsewhere herein.

As will be understood, the reaction chamber will typically be fabricated from a thermally conductive material so as to allow for transfer of heat energy from the gas within the jacket to the interior of the reaction chamber. In that regard metal and metal composite materials are preferred. The jacket may be configured to completely surround the reaction chamber with a heated gas, or may in some embodiments be configured to contact only a portion of the external surface of the reaction chamber. A portion of the external surface may be a roof, and/or one or two side walls, and/or or a floor of the reaction chamber.

In one embodiment, the present apparatus is configured so as to be capable of controlling the temperature of a carbon fibre precursor residing within the reaction chamber to within 10, 9, 8, 7, 6, 5, 4, 3, 2, 1, 0.9, 0.8, 0.6, 0.5, 0.4, 0.3, 0.2 or 0.1 degrees Celsius of a predetermined temperature. In a preferred form the present apparatus is configured so as to be capable of controlling the temperature of a carbon fibre precursor residing within the reaction chamber to within 1 degree Celsius of a predetermined temperature.

In one embodiment, the apparatus is configured to allow for temperature control within the aforementioned limits for at least about 80, 81, 82, 83, 84, 85, 86, 87, 88, 89, 90, 91, 92, 93, 94, 95, 96, 97, 98% of the length of carbon fibre precursor resident with the reaction chamber.

In one embodiment, the apparatus is configured to allow for temperature control within the aforementioned limits for at least about 80, 81, 82, 83, 84, 85, 86, 87, 88, 89, 90, 91, 92, 93, 94, 95, 96, 97, 98% of the residence time of carbon fibre precursor in the reaction chamber.

The aforementioned parameters relating to temperature control may be applied to the temperature of a gas within the reaction chamber, and furthermore to the temperature control of the gas along the length of the reaction chamber.

The aforementioned parameters relating to temperature control may also be applied to the temperature of an inner surface of the reaction chamber, and furthermore to the temperature control of the surface along the length of the reaction chamber.

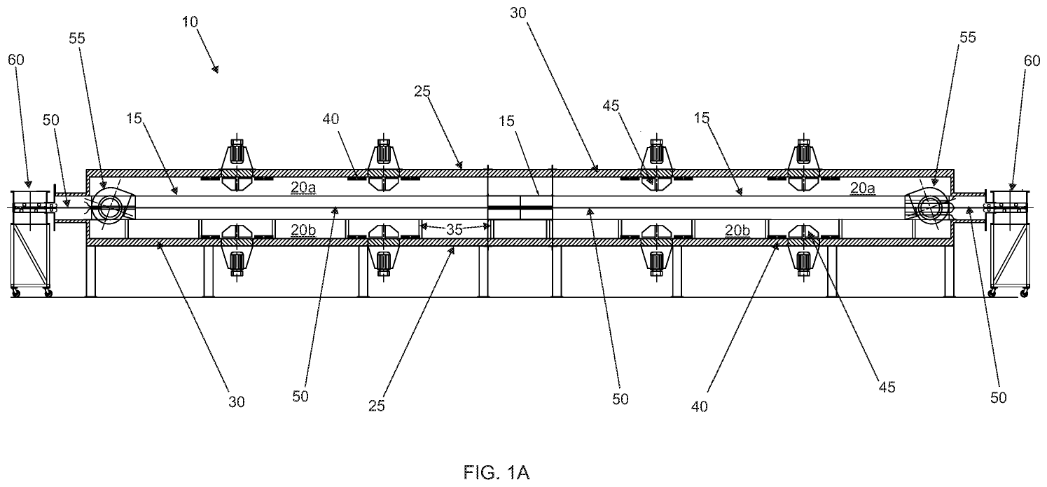

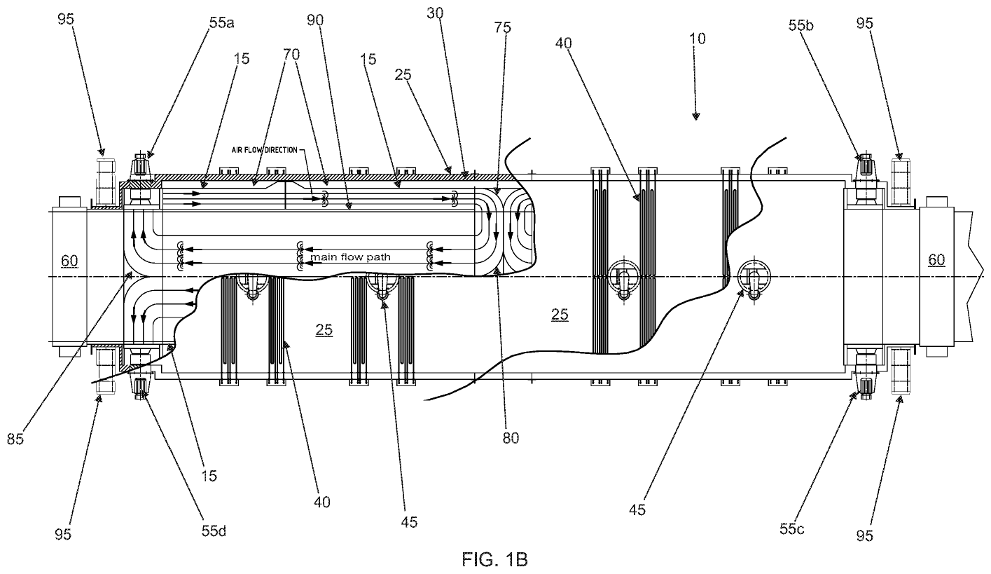

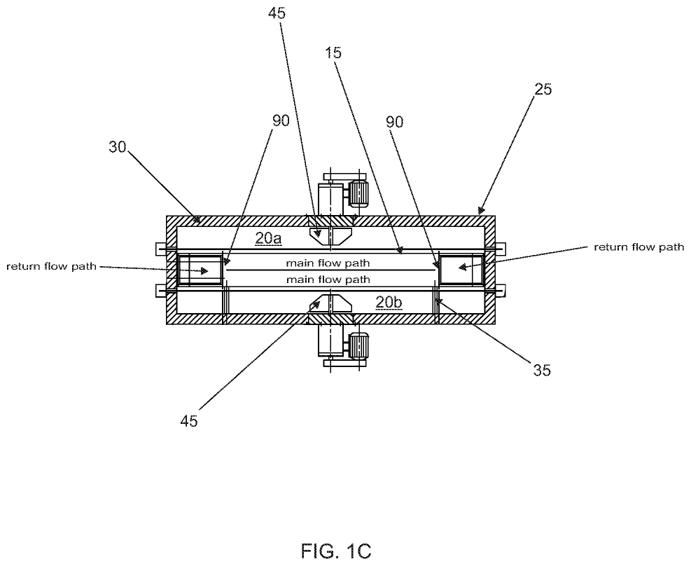

Turning now to FIG. 1A, there is generally shown an apparatus 10 of the present invention, being configured to pre-stabilize a PAN precursor under predetermined temperature and with a non-oxidizing gas environment. The apparatus 10 comprises a reaction chamber, which in this embodiment is an elongate muffle 15. The muffle 15 is fabricated from a heat conductive metal formed into a hollow shaft-like arrangement that is disposed horizontally within the apparatus 10. Contacting the upper and lower faces of the muffle 15 exterior for the vast majority of the muffle 15 length are two bodies of heated air 20a, 20b.

Sheet or plate metals will be suitable for fabricating the muffle in many instances. Stainless steel will be useful for many applications. The muffle is constructed so as to ensure general structural integrity is maintained under the temperatures at which the apparatus will be operated. In constructing consideration will typically be given to preventing any buckling or other distortion that may arise during operation. Given the benefit of the present specification the skilled person is amply enabled to determine a useful material for a given application.

As will be appreciated, given the need to maintain a non-oxidizing atmosphere within the muffle 15, the muffle (and any associated conduit that conveys non-oxidizing process gas) is constructed so as to be substantially gas-tight to the extent at least that gas from heated air bodies 20a, 20b is unable to pass to the interior of the muffle 15.

The heated air bodies 20a, 20b are retained about the muffle 15 by a housing 25. The housing 25 surrounds the muffle 15, and internally comprises an insulation layer 30.

The muffle sits between and is maintained in position by a series of support legs (two of which are marked 35). The support legs 35 do not substantially inhibit movement of air within the heated air body 20b.

The heated air bodies 20a and 20b are heated by electrical resistance heating elements (two of which are marked 40) which span the width of the housing 25 (as more clearly shown in the plan view of FIG. 1B). The heating elements are spaced at regular intervals along the length of the apparatus 10, and directly heat the air of the heated air bodies 20a and 20b.

Thus, the air of the air bodies 20a and 20b is heated, with the air in turn heating the outer surfaces of the muffle 15. The air of the heated air bodies 20a, 20b are stirred using fans (two of which are marked 45) so as to more evenly distribute the heat contained therein, and in turn provide for more even heating of the muffle 15 along its considerable length. Applicant proposes that the even heating of the muffle 15 results in the even heating of the process gas within the muffle 15. The process gas in turn heats the continuous length of carbon fibre precursor 50 evenly, such that the temperature of a desired chemical reaction in the precursor 50 may be very precisely controlled along the entire length of the precursor 50 within the muffle.

As an alternative to the embodiment of the drawings, there may be no heating elements and instead the air about the muffle is heated external to the apparatus. For example, the air about the muffle may be heated by a natural gas source, or an electrical source that is disposed outside the apparatus.

As will be discussed more fully infra with regard to the recirculation of nitrogen process gas within the muffle 15, centrifugal fans 55 are provided at each end of the muffle 15.

In order to maintain a controlled atmosphere, the muffle 15 is typically constructed so as to inhibit against or prevent ingress of any heated gas 20a and 20b within the housing and circulating about the muffle.

The muffle 15 is fitted at each end with a gas curtain generating device 60. The gas curtain generating devices 60 address the need to exclude atmospheric oxygen from the muffle 15, such that a chemical reaction or other process that occurs in the muffle 15 occurs in a substantially non-oxidizing atmosphere. In certain process steps of carbon fibre manufacture oxidation can lead to undesired changes in the physical or chemical characteristics of the carbon fibre precursor being processed, or may result in complete destruction of the fibre.

In combination with the superior temperature control provided by the even heating of the muffle 15, the exclusion of atmospheric oxygen further limits undesired changes in the physical or chemical characteristics of the carbon fibre being processed.

The gas curtain generating devices 60 of the present apparatus are configured to balance the flows of input gases and output gasses so as to contain exhaust gases within the apparatus while still limiting the ingress of potentially damaging atmospheric oxygen. This balancing may be achieved by the use of a marker gas source adapted to dispense a marker gas about the entry and/or exit port(s) of the muffle 15 and temperature measuring means disposed at location(s) allowing for detection of mixing of the marker gas with the process gas by reference to the temperature of the mixed marker and process gasses, such that the marker gas is warmer or colder than the process gas, and (i) when atmospheric oxygen is being drawn into the muffle 15 via the entry or exit port the process gas is mixed with and warmed or cooled by the marker gas, and/or (ii) when exhaust gases are escaping via the entry or exit port the marker gas is mixed with and warmed or cooled by the process gas, situations (i) and (ii) being discernible by analysis of the temperature reading(s) of the temperature measuring means. Applicant has found that the presence of a marker gas about the entry or exit ports provides means for balancing the flow of gases through the muffle 15. This allows an operator to finely balance the flow of gases through the reaction chamber such that the ingress of atmospheric oxygen into the reaction chamber is lessened, while also lessening the egress of toxic exhaust gases from the muffle 15 into the operating environment.

Description is now provided to more fully describe the flow of process gas (which in this exemplary embodiment is nitrogen gas) within the muffle. The flow of inert nitrogen gas is important in carbon fibre production given that a function of the gas to control the temperature (and therefore extent) of desired and undesired chemical reactions in a carbon fibre precursor.

Thus the temperature may be controlled so as to encourage a particular chemical reaction or process. The nitrogen gas may also be used to carry away undesirable by-products to an exhaust system. Any one or more of the rate of gas flow, the temperature of the gas, the direction of gas flow (relative to the precursor fibre long axis or the muffle long axis) and the laminarity (or lack of laminarity) of the gas flow may be carefully controlled. As discussed supra, the maintenance of heated air bodies 20a, 20b about the muffle 15 improves the uniformity of heating the muffle 15 via the outer surfaces thereby improving the uniformity by which the nitrogen gas within the muffle 15 is heated. Applicant proposes that further improvement with regard to improving the uniformity of heating may be obtained by configuring the present apparatus to establish certain patterns of gas flow within the muffle.

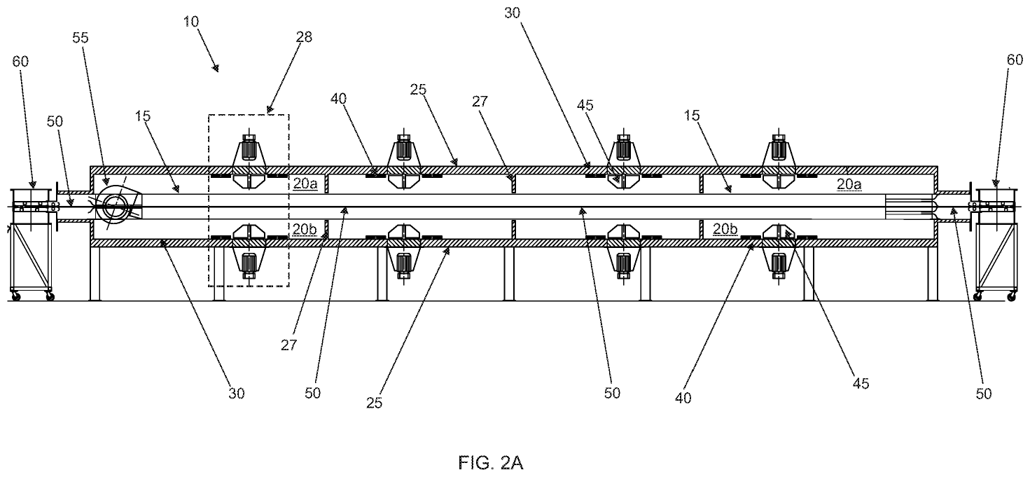

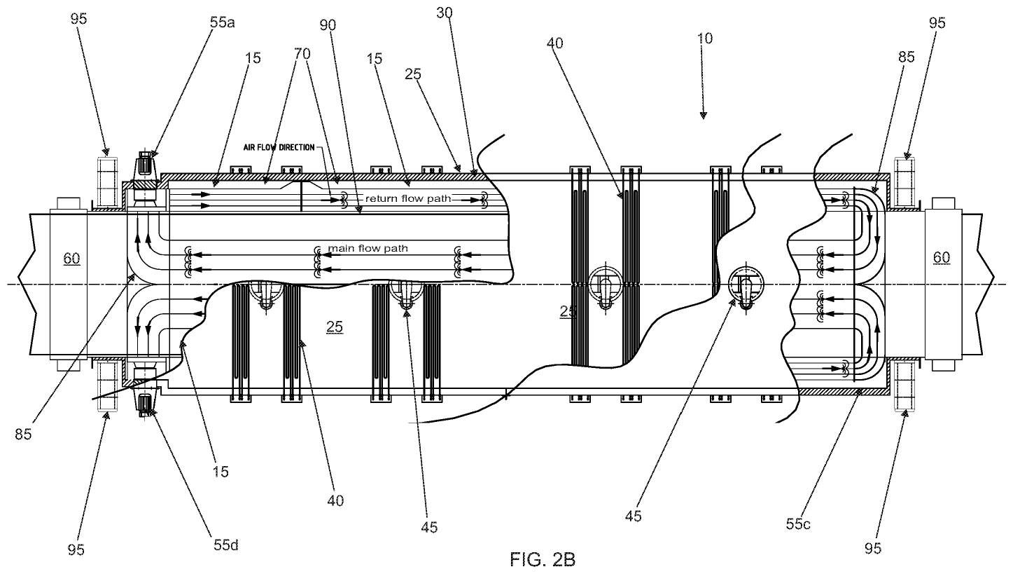

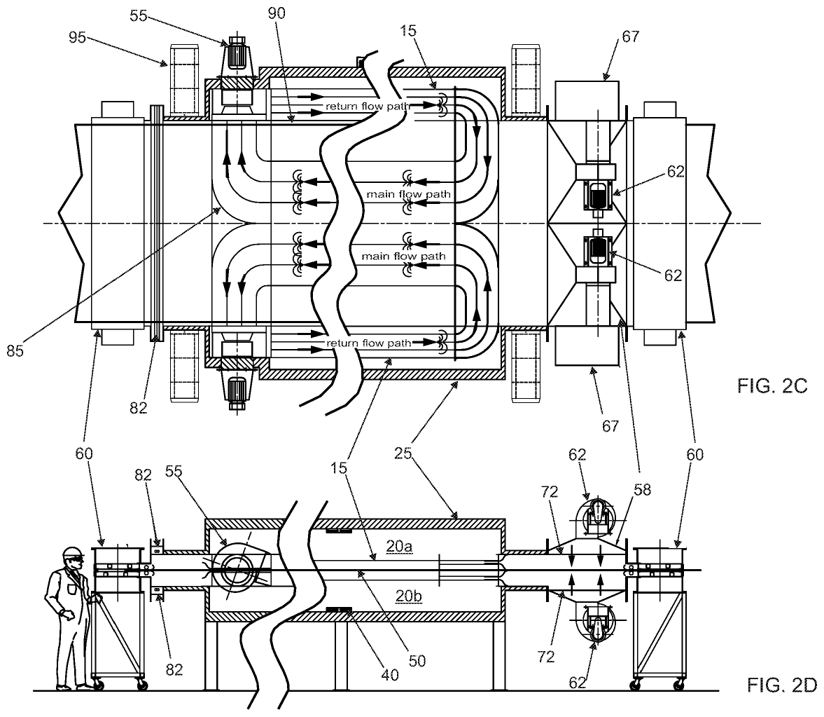

As is known in prior art ovens, a process gas may be recirculated in a “centre-to-end” scheme. In such embodiments, the nitrogen gas is recirculated in two opposing circuits. In the context of the present invention, for each circuit the nitrogen gas is conveyed from a central point in the muffle toward either the entry port or the exit port (depending upon which of the opposing circuits is under consideration), and then on a return path back to the central point in the muffle. Applicant proposes that improvement is found where the gas is directed to a discrete return path. This is distinct from prior art centre-to-end process gas recirculation means which draw process gas outside the reaction chamber from one end by way of a fan external to the chamber and then return the gas (via a path external to the chamber) to the other end of the chamber. Without wishing to be limited by theory, Applicant proposes that in these prior art methods of process gas recirculation, unacceptable temperature deviations of the process gas are allowed thereby compromising temperature control especially where relatively low process gas velocities are used. By contrast, the present apparatus maintains the process inside the reaction chamber (muffle 15) while still providing for centre-to-end recirculation circuits (or alternatively end-to-end circuits, one of which is shown at FIG. 2C) to be established.

In the preferred embodiments of the drawings, and as clearly shown in FIG. 1B, four centre-to-end recirculation circuits (one being fully shown at the top left, as drawn) are established by way of four independent centrifugal fans 55. Considering the fan 55a at the top left (as drawn) it will be noted that air is drawn into the fan in a path that is coaxial to the fan axis of rotation and expelled at right angles to the axis of rotation. The nitrogen gas expelled by the fan 55a is on the return path of the centre-to-end circuit and travels left to right (as drawn). Given that the nitrogen process gas in the return path is retained within the muffle 15, the gas is warmed by virtue of the fact that the surrounding heated air bodies 20a, 20b contact and heat the outside of the muffle 15. Moreover, it will be noted that a space 70 exists between the muffle 15 outer lateral face and the insulation layer 30 so as to allow heated air to flow between heated air bodies 20a and 20b. This flow of heated air through the space 70 causes heating of the lateral wall of the muffle 15, which in turn acts to heat the nitrogen process gas in the return path of the centre-to-end circuit.

At the end of the return path, a first vane 75 acts to deflect the nitrogen gas 90 degrees to toward a second vane 80 which deflects the gas flow a further 90 degrees. The gas as deflected by the second vane 80 is the main (outward) flow path of the centre-to-edge circuit during which the gas contacts precursor fibres (not shown) within the muffle 15. In this main flow path, the nitrogen gas has substantially laminar flow characteristics.

The main flow path terminates at the vane 85 which deflects the nitrogen gas toward the intake of centrifugal fan 55a so as to complete the circuit.

The nitrogen gas in the return flow path is prevented from mixing with that in the main flow path by a divider 90. One benefit of this arrangement is that the return gas is retained in the compartment defined by the divider 90, and is therefore forced to complete the full return path (and up to the vane 75) and is therefore properly heated before it is permitted to enter the main flow path. The divider essentially prevents the return flow path gas from “short circuiting” the circuit in so far as gas that has just been expelled from the fan 55 is prevented from entering the main flow path. In being forced to travel the entire length of the return flow path, nitrogen gas is able to absorb more heat energy from the overlying heated air body 20a, and underlying heated air body 20b, and also the heated air in the lateral space 70.

A further advantage of the divider is that disruption of the main flow path by mixing with gas on the return path is avoided. As will be appreciated, gas within the return flow path travels in an opposite direction to that in the main flow path. If the two paths are not at least partially physically separated unacceptable turbulence would be created by the counter-current flows established. As is well known to persons skilled in the art of carbon fibre manufacture, turbulence about the precursor fibres can be detrimental to production.

The divider 90 will typically be fabricated from a heat conductive material (such as a metal) such that some transfer of heat can occur from gas in the return flow path to gas in the main flow path. In some embodiments, the divider 90 comprises minor discontinuities or perforations so as to gently dispense small amounts of warmed nitrogen gas for in the main flow path can occur. Again, this may assist in ensuring the even warming of the interior of the muffle 15.

In an alternative embodiment, gas in the return flow path may exit the chamber via a dedicated duct rather than remain within the muffle. The duct may open from the edge of the muffle 15 and a carry a process gas to the centre of the muffle 15, where it enters the interior of the muffle 15 to form the main flow path. The duct will typically be fabricated from a material that has useful heat transfer qualities such that heat is transferred from the heated air bodies 20a or 20b to nitrogen gas flowing within the duct.

As will be appreciated the preferred apparatus 10 of the drawing shown in FIG. 1B, there are in fact four centre-to-end gas recirculation circuits, each driven independently by centrifugal fans 55a, 55b, 55c and 55d. Apart from orientation with respect to air flow direction, the four circuits are substantially identical to each other.

In this preferred embodiment, the direction of flow of nitrogen gas within the muffle 15 is substantially parallel to long axis of the muffle 15 for the entire circuit. Furthermore, the plane of flow of nitrogen gas within the main flow path and the plane of the return flow path of the muffle 15 are not angled with respect to each other. The flow path of the nitrogen gas where the gas is redirected by way of the vanes 75, 80, 85 through 90 degrees is further co-planar with the main flow path and return flow path. Other arrangement of with regard to gas flow paths are of course within the ambit of the present invention.

The plan view of FIG. 1B also shows clearly the exhaust outlets 95. The exhaust outlets 95 have a structure and function well understood by the skilled person, and for the purposes of clarity and brevity will not be described in any detail.

Considering now FIG. 1C, this end-on cross-sectional view shows more clearly the spatial relationship between the main flow path, and the associated return flow paths.

The embodiment of FIG. 1 operates on a centre-to-end gas recirculation system. Turning now to FIG. 2A there is shown an embodiment of the apparatus which operates by way of an end-to-end gas recirculation internal to the muffle. In this configuration it is even more important to maintain the distributed heat and air recirculation on the outside of the muffle.

An advantage of the end-to-end design is that an exhaust is required at one end only (compared to the centre-to-end design which is typically balanced and exhausted at both ends).

A further advantage of the end-to-end design is that without a midpoint discharge plenum both above and below the tow band and discharging in both directions, there is no longer an obstruction at the midpoint and accordingly there is no requirement to provide midpoint access for cleaning. The centre-to-end midpoint distribution of the atmosphere may be acceptable in an oxidation oven where exclusion of air is not a requirement. In that case, this area may be accessed via a door opening for cleaning. However where a tightly controlled atmosphere is required, providing access to the midpoint for cleaning represents a potential route for atmosphere leakage. This potential route for leakage is obviated for embodiments of the present invention operable of an end-to-end basis.

Yet another advantage of the end-to-end design is that is allows for the large catenary from a heavy tow and a long chamber of unsupported fibre. The fibre is free to sag without concern for fitting through the reduced dimension of the midpoint slot of a centre-to-end design.

In the case of a particularly long muffle and particularly in the case of an end-to-end design (i.e. process gas flowing in one direction over the precursor for the operable portion of the muffle) the present invention provides for the ability to closely control external heating of the muffle (and optionally in combination with the ability to closely control associated air recirculation) to provide two or more individually controlled temperature zones. For example, a heating element about a first area of the muffle may be set to a higher or lower temperature than a heating element about a second area of the muffle such that precursor passing through the first area is heater to a greater or lesser extent than when passing through the second area.

By this arrangement, the muffle at the precursor entry end may be maintained at the correct set temperature in spite of the heat load at the entry being greater due to the potential for cold entry of the precursor. If the precursor should generate heat (exotherm) down the length as it is heated, then the heating zones down the length may be operated at a lower temperature to compensate. This is a particular advantage of the muffle and external recirculation design as provided by the present invention.

To facilitate the division of muffle into temperature zones, a series of baffles (two of which are marked 27) may be disposed at regular intervals along the apparatus. The baffles are thermally insulating and may be provided in the form of an extension from the main housing insulation layer 30. It will be noted form FIG. 2A that the baffles extend inwardly so as to contact the muffle 15 exterior, thereby preventing lateral flow of heated gas from one side of the baffle 27 to the other. In the preferred embodiment of FIG. 2A, the baffles 27 divide one set of heating elements and recirculating fans (such as that bound by the dashed square marked 28) from an adjacent set. Thus, one set of heating elements and recirculating fans may be used to control the temperature of the muffle in a first temperature zone, and another set of heating elements and recirculating fans may be used to control the temperature of the muffle in a second temperature zone. Within a zone either one or both fan speed and heating element may be adjusted so as to achieve a desired muffle temperature or precursor temperature for that zone.

In some embodiments, the apparatus may comprise a cooler configured to rapidly cool product under atmosphere upon exit from the muffle. Reference is made to FIG. 2D which shows the cooler 58 positioned immediately before the exit curtain 60. In one embodiment, the cooler is a two-stage cooler. Stage one may be a conventional water-cooled chamber having a high emissivity water cooled or other fluid cooled inner wall. In the second stage, the product may be passed between one or two plenum plates (above and below the product band). The plenum plates 72 may comprise a plurality of holes (not shown) configured to direct jets of cooling atmosphere onto the surface of the product. This impingement dramatically increases cooling efficiency compared to quiescent cooling at lower temperatures.

The plenum plates may be pressurised under atmosphere from sealed recirculation fans 62. The atmosphere typically passes from a fan 62, through a heat exchanger 67 to the plenum plates 72. After the atmosphere has been impinged onto the product and has been heated in the process, it is drawn off to the suction side of the recirculation fan 62 and past a heat exchanger 72 to remove the heat gained. A filter (not shown) may be placed in the circuit so as to collect the stray filaments that may otherwise circulate.

In order for the atmosphere of the cooling process to be preserved and in order to prevent air ingress into the cooling circuit, it is typical to have an effective end seal or curtain due to the proximity to the high velocity recirculation of atmosphere. It would not be possible to exclude air from entering the process without an effective curtain. The curtain is then used to further cool the product prior to exiting the process. The curtain is also used to maintain the balance of velocity pressure from the cooler.

FIG. 2C and FIG. 2D show a further feature being a preheater 82, which in this embodiment is an electrically powered heating element disposed immediately after the entry curtain 60. An advantage of the preheater is that residence time and/or the length of muffle may be shortened by a means of rapidly preheating the precursor fibre.

On production lines, the mass throughput of fibre becomes significant and the use of a preheater to rapidly increase the temperature of the incoming precursor up to the processing temperature, or at least closer to the processing temperature is advantageous in decreasing the chamber length. Rapidly increasing the precursor temperature upon entry can be considered as saving processing time that would be otherwise lost. The greater the rate of movement of the incoming precursor or the more mass throughput, more input power is required for preheating. Where the precursor enters at ambient temperature and is exposed to the radiant heat of a furnace above say 600° C. the rate of heat input may be relatively high. However, where it is a low temperature process typically under 400° C. at the entry end, the rate of heat input may be relatively low. Heat is transferred by radiation from the side walls and by convection from the passing atmosphere, both of which are relatively slow at lower temperatures. Accordingly, the desired process reaction only takes place some distance down the chamber which results in a longer chamber being required. This adds length and cost to the process line.

As discussed above, heating is not only by means of radiant heating from the chamber wall but also by the convection of the heated atmosphere being circulated in the chamber. This heating effect is relied upon more in lower temperature ovens and furnaces whereas radiant heating is relied on more in higher temperature applications. Where the mass throughput and speeds of fibre is higher, the atmosphere velocity would need to be significantly higher in order to heat the product to temperature in a short period of time. Higher velocities require larger and more expensive high temperature fans. This atmosphere may be an inert atmosphere which may be recirculated.

Preheating the entry curtain atmosphere may assist in the pre-heating of the incoming precursor, however there are limits as to the maximum curtain gas temperature that may be used. Furthermore, for high production loads a considerable amount of heated curtain gas would be wasted. In one embodiment, the preheater is configured to rapidly heat the passing fibre to slightly less than the desired process temperature over a very short distance after the entry curtain. In this way the product is heated within the protective atmosphere and arrives at the temperature processing chamber having already absorbed the majority of the required heat energy. Consequently the product achieves the required processing temperature sooner, thereby shortening the required chamber length. Furthermore, there is less of a cooling effect of the chamber upon entry of precursor. Where the mass of product is insignificant compared to the energy stored in the chamber and in the recirculating atmosphere, a relatively low energy saving results. However, on high volume production lines a relatively high energy saving typically results.

Embodiments of the invention configured to impart heat rapidly to the passing fibres without making physical contact and without relying on impinging the product with high temperature atmospheres are preferred. In one particular embodiment, the pre-heater is comprised of one or more heating elements (such as fast response infra red heating elements). The heating elements may be provided as a narrow band that spans the breadth of the passing fibres, as shown in the plan view of FIG. 2C. These elements may be on one side (such as upper or lower) only or on both sides (upper and lower, as shown in lateral view of FIG. 2D) of the passing band of product according to the power density required. The elements may be switched on and off rapidly or otherwise regulated to provide a required steady state heat input. The use of a fast response infra red heater permits rapid reduction in heating should the production line stop.

The temperature rise of the passing fibre is a function of the mass throughput, the emissivity and the radiating source. The efficiency under these conditions is very high and the space required is minimal. The method is particularly suited for steady state load conditions, but may be useful in other circumstances.

In some circumstances, it is necessary or desirable to rapidly decrease the temperature of a material being processed in the oven. As is understood by the skilled person, the temperature of a carbon fibre precursor may be increased to an excessive level and in some circumstances uncontrolled reaction may result. The provision of a separate reaction chamber (muffle) within the housing allows for the venting of heated gas from the space about the muffle to the outside. Importantly, the presence of the muffle allows for the atmosphere about the precursor (i.e. within the muffle) to remain unaffected. The venting means may be passive (such as a simple mechanical shutter that is openable or closable) which passively allows for the release of heated gas to the environment external to the housing. The venting means may also provide for passive means of allowing the entry of cooler air from the environment surrounding the housing. In some embodiments, the venting means may include an active means of injecting cooler air into the space surrounding the muffle and/or extracting heated air from around the muffle. In any event, the integrity of the controlled atmosphere within the muffle is preserved.

Activation of the venting means operates so as to cool the muffle wall, and consequently the fibres passing through the muffle.

Advantageously, some embodiments of the venting means are separate to a gas exhaust system of the apparatus. In such circumstances, activation of the venting means does not provide any additional demand on the waste gas exhaust system. By comparison a conventional oven is not easily be able to cool the insulated walls of the oven unless a considerable amount of fresh cold atmosphere is flushed into the oven. Such purging would require the exhaust gas processing system to have the capability of dealing with the sudden increase in exhaust gases.

As is known in the art, carbon fibre precursor may be conveyed through a reactor chamber by the use powered rollers configured to convey the precursor at a predetermined speed. Passive guide rollers may be further included as required.

Generally, all rollers are disposed external to the reaction chamber so as to avoid any disturbance of the flow of process gas therewithin.

In many chemical reactions, provision of a controlled atmosphere (such as a substantially non-oxidizing atmosphere) is essential. In that regard, the present apparatus may have a non-oxidizing gas source in fluid communication with the interior of the reaction chamber. The non-oxidizing gas source may be configured to inject fresh gas into the reaction from time to time, as required. The freshly injected gas may be pre-heated so as to prevent or inhibit any disturbance to the even temperature established within the reaction chamber.

As discussed elsewhere herein, gas curtains may be used to exclude atmospheric oxygen from the reaction chamber. Of course, it must be possible to feed a precursor into the reaction chamber, however a corollary is that oxygen may leak into the reaction chamber. The use of a marker gas about the entry or exit ports provides means for balancing the flow of gases through the reaction chamber. In such an embodiment, the gas curtains allows an operator to finely balance the flow of gases through the reaction chamber such that the ingress of atmospheric oxygen into the reaction chamber is lessened, while also lessening the egress of exhaust gases from the reaction chamber into the operating environment.

Without an ability to finely balance the flow of gases, the reaction chamber may be set up set up in an unbalanced (albeit operable) manner leading it to either (i) exclude atmospheric oxygen by the maintenance of a net flow of gas from the reaction chamber to the atmosphere (this allowing the escape of significant amounts of exhaust gases), or (ii) prevent the escape of exhaust gases (this allowing the ingress of damaging atmospheric oxygen into the reaction chamber). The ability to analyse gas flows within a reaction chamber by the use of a marker gas allows for the manipulation of variables (such as exhaust extraction rate, air curtain flow rate, process gas flow rate, and the like) to establish process conditions such that little or no ingress of atmospheric oxygen into the reaction chamber occurs, and additionally with little or no egress of exhaust gases.

The balancing of gas flows is typically effected by altering the rate of extraction of exhaust gases, and/or altering the flow rate of input gases. In one embodiment therefore, the exhaust system draw is adjustable, for example by adjusting an exhaust fan revolution rate.

In another embodiment, the flow rate(s) of input gas(es) is adjustable. It is a further advantage of that adjustment of input gas flow rates allows for minimization of the amount of process gas to be used. Adjustment of flow rates can be achievable by any means known to the skilled artisan including the use of a valve, constrictor, choke, diverter, altering pressure of the gas source, and the like.

Balancing the flow of gases further provides an ability to minimise cooling of the process gas by mixing with (i) a curtain gas or (ii) a dedicated cooling gas. For example, when pre-heated process gas is introduced into the discharge end of the reaction chamber an incorrect balance of gas flows and exhaust will typically result in either cooling the pre-heated process gas from the cooling gas (or indeed heating the cooling gas) thereby reducing overall effectiveness or thermal efficiency. The most difficult area is at the discharge end of the reaction chamber where pre-heated process gas is introduced into the muffle right adjacent to the cooler where cooling gas is introduced.

As used herein, the term “marker gas” is intended to mean a gas that is introduced for the purpose of potentially mixing and cooling the process gas. The marker gas may be dedicated to aforementioned purpose, or may serve another purpose. For example, the marker gas may also be a cooling gas (for the cooling of treated precursor before exiting the reaction chamber), or a curtain gas (for establishing a gas curtain at an exit or entry port of the reaction chamber). Given the possibility of the marker gas contacting the precursor or oxidation sensitive parts of the reaction chamber, the marker gas is typically an inert gas which does not substantially alter or degrade a precursor under treatment by the reaction chamber, or a component of the reaction chamber per se. In some circumstances, the marker gas is the same species as the process gas. Typically, the marker gas is an inert gas such nitrogen, carbon dioxide, helium or argon. To that end it will be understood that a marker gas may be a gas that facilitates a desirable reaction within the reaction chamber, or inhibits an undesirable reaction.

The ability to balance gas flows is improved whereby the marker gas is injected at a temperature which is significantly lower than that of the process gas. Thus, a relatively small amount of cold marker gas mixed with the process gas stream will lead to a measurable alteration of the exhaust gas temperature, thereby indicating the net flow of atmospheric oxygen into the reaction chamber.

In one embodiment, the apparatus comprises a cooling means configured to cool the marker gas to a temperature less than about 30, 25, 20, 15, 14, 13, 12, 11, 10, 9, 8, 7, 6, 5, 4, 3, 2, 1, or 0 degrees Celsius. Preferably, the cooling means is adapted to cool the marker gas to a temperature less than about 15 degrees Celsius.

The primary function of the process gas is typically the bulk displacement of undesired gases from the main chamber (such as oxygen) in which case it is also typically an inert gas. Alternatively the process gas may be a gas that facilitates a desirable reaction within the reaction chamber, such as the use of hydrogen to chemically reduce a precursor.

In one embodiment, the marker gas is a mixture of gases. For example, the marker gas may be a combination of cooling gas and curtain gas. Alternatively, a combination of cooling gas and curtain gas may have no function as a marker gas.

It will be appreciated that the temperature measuring means is/are located in position(s) of the reaction chamber where the process gas and marker gas will mix when (i) atmospheric oxygen is being drawn into the reaction chamber via the entry or exit port the process gas is mixed with and cooled by the marker gas, and/or (ii) when exhaust gases are escaping via the entry or exit port. In one embodiment the temperature measuring means is/are placed in one or more of the following locations:

Typically, the temperature measuring means are remotely readable and preferably electric or electronic in nature. Thermocouple devices are particularly suitable in the context of the present invention.

The ability to analyse gas flows within a reaction chamber as provided by this embodiment of the present apparatus allows for the automation of reaction chamber set up and operating conditions. For example the system, in some embodiments, may be partially or completely controlled by a processor-based device such as a computer. Temperature readings may be detected by thermocouples operably connected to a computer. Software-based algorithms may be used to analyse the readings, with the software directing control of input gas flow rates and exhaust draw rates in order to optimise running of the system. Rates may be altered by way of electrically or electronically controllable valves of the type well known to the skilled artisan. Such automated systems may run continuously during the processing of precursor thereby ensuring that optimal conditions are maintained.

In one embodiment, the gas curtain has gas flow characteristics adapted to disrupt atmospheric oxygen bound to a precursor passing through the gas curtain.

In a further aspect, the present invention provides a gas curtain for a reaction chamber, the gas curtain having gas flow characteristics adapted to disrupt atmospheric oxygen bound to a precursor passing through the gas curtain.

Applicant has found that traces of atmospheric oxygen bind to the surface of precursors (such as carbon fibre intermediate), and that the use of a gas curtain having the aforementioned gas flow characteristics can be effective in removing the bound oxygen.

In one embodiment, the gas curtain comprising two regions: the first region having gas flow characteristics adapted to avoid the ingress of atmospheric oxygen into the reaction chamber, the second region having gas flow characteristics adapted to disrupt and displace atmospheric oxygen on a precursor passing through the gas curtain.

The zone which is disposed closest the entry or exit port of the reaction chamber (i.e. immediately adjacent to the atmosphere) is substantially incapable of disrupting the bound oxygen, being configured to avoid turbulence and introduction of atmospheric oxygen.

Thus, processing intermediate initially enters the first zone of the gas curtain. The flow in this region is, in one embodiment, substantially laminar. As used herein the term “substantially laminar” is intended to include the circumstance whereby the direction of flow is substantially coplanar with the walls of the chamber and/or the precursor. This arrangement leads to the substantial inhibition of turbulence about the interface between the first zone and the atmosphere which could lead to the ingress of oxygen into the reaction chamber. At this point, molecular oxygen is still bound to the surface of the precursor. However, once moved into the second zone the bound oxygen is substantially disrupted by the flow characteristics of gas in the second region, which is substantially turbulent. In one embodiment, the gas flow in the second region is directed substantially perpendicularly to the plane of the precursor.

In one embodiment, the apparatus comprises one, several or a plurality of jets configured to direct gas at high velocity onto a surface of the precursor. Preferably, the jets are configured to direct gas onto all surfaces of the precursor. Where the precursor is substantially ribbon-like (as for the manufacture of carbon fibre) the apparatus comprises jets adapted to direct gas onto the upper and lower surface of the ribbon.

Suitably, the jets may be formed by aperture(s) disposed within a metal plate. The plate is typically fabricated from stainless steel, of thickness about 10 mm. Aperture diameter in some embodiments is typically about 1, 2, 3, 4, or 5 mm, and preferably about 3 mm. A positive gas pressure is provided behind the plate. The pressure is typically less than about 1 kPa, with the gas being ejected at velocity through the apertures. Impingement velocity will vary, at least in part according to the fragility of the precursor, and is typically less than about 0.5 m/sec.

The apparatus may comprise two horizontally opposed, substantially parallel plenum plates, each plate being devoid of apertures in a first region (to form the first, non-turbulent, region of the gas curtain) and having a plurality of apertures in the second region (to form the second, turbulent, region of the gas curtain). Typically, the second region is of greater length than the first. The ratio of length of first region to second region may be about 3:1. The absolute dimensions of the first and second may be varied by the skilled person according to the general dimensions of the reaction chamber and/or the precursor.

The number of apertures, length of curtain, and the flow rate of curtain gas determines the impingement velocity on the product. Control of impingement velocity may be required in order to customize for a particular precursor. For example, impingement velocity may be decreased to flutter or movement of the intermediate so as to avoid damage. Advantageously, in one embodiment the aforementioned parameters are adjustable. In one embodiment the plates are configured to be replaceable to facilitate customization.

Another parameter that may be varied is the distance between the plenum plates. Accordingly, in one embodiment of the apparatus the plates are adjustable so as to allow variation in the distance between the plates. Adjustability of the gap between the plenum plates allows for optimization of this distance. A typical aim of the adjustment will be to provide the smallest workable gap allowing for the catenary formed by the precursor, together with the lowest oxygen ingress at the lowest inert gas consumption. The plates may be adjusted in a perpendicular direction with reference to the precursor, with external gauges indicating the position of the internal plenum plates.

In a preferred embodiment of the invention the curtain gas is also the cooling gas, with the gas curtain comprising or consisting of or consisting essentially of a substantially turbulent region. The substantially turbulent region of the gas curtain may be formed by a plate having one, several or a plurality of jets configured to direct gas at high velocity onto a surface of the precursor. In this embodiment, the curtain acts also as a cooling means, lowering the temperature of the precursor before exposure to atmospheric oxygen. Cooling precursor by the application of a turbulent cooling gas provides for rapid and effective decrease in temperature of the precursor. By contrast, prior art methods relying on the conduction and/or radiation of heat away from the precursor are significantly slower in cooling the intermediate. Inclusion of a convective means to dissipate heat (such as by the impingement of a gas stream on or about the precursor) provides more rapid and complete cooling of the precursor.

Preferably, the cooling gas curtain consists of, or consists essentially of, a substantially turbulent region. Cooling gas curtains as described (and also apparatus for producing same) are particularly advantageous when used at the exit port of the reaction chamber, at which location there is no requirement for a region having substantially laminar gas flows.

An economic advantage is further provided by this embodiment given that the cooling gas also functions to exclude atmospheric oxygen from the reaction chamber.

In one embodiment of the system, the entry and or/exit port(s) comprise adjustable choke(s) and/or baffle(s).

In a further aspect, the present invention provides entry and/or exit port(s) for a reaction chamber, the port(s) comprising adjustable choke(s) and/or baffle(s).

An adjustable choke may be placed at the entry and/or exit portal(s) either ends of the heating and cooling chambers. It has been found that having the smallest possible workable gap for the precursor to pass through further decreases the ingress of atmospheric oxygen into the reaction chamber.

The choke mechanism may comprise 1 or 2 sliding plates covering the entry or exit port. Preferably, the choke comprises 2 sliding plates with each plate sliding independently of the other such that the position of the slot formed between the two plates (for receipt of precursor) may be altered (between an upper position and a lower position). An advantage of this embodiment is the ability to feed the precursor in a higher position to take account of catenary of the intermediate. Where the reaction chamber comprises plenum plates (as discussed supra) the ability to raise the precursor above the lower plate may be necessary.

In some circumstances, the narrow opening created by the choke creates a high velocity of escaping process gas. Without wishing to be limited by theory it is proposed that this area of high velocity reduces ingress of atmospheric oxygen into the chamber.

The ability to adjust the build-up of free fibres over continuous use is inevitable. It is therefore necessary to include access into the reaction chamber interior for maintenance. The ability to open the chokes facilitates removal of such debris.

The baffle(s) have a choke-like function acting to inhibit the entry of environmental gases into the reaction chamber, while still allowing for the passage of materials into and out of the reaction chamber. The baffle(s) is/are typically plate-type baffle(s), and may be adjustable independently to any choke(s) present. In other embodiments, a choke and baffle are adjustable in a dependent manner.

In one embodiment, the apparatus comprises (i) a vacuum pump configured to apply a vacuum or partial vacuum to the reaction chamber or portion thereof to substantially remove a first undesired gas and (ii) means for admitting a second desired gas into the vacuum or partial vacuum.

In another aspect the present invention provides a method of replacing a first undesired gas with a second desired gas in a reaction chamber, the method comprising the steps of: (i) applying a vacuum or partial vacuum to the reaction chamber or portion thereof to substantially remove the first gas and (ii) admitting the second gas into the vacuum or partial vacuum. In some embodiments, the level of vacuum is greater than about 5, 6, 7, 8, 9, 10, 11, 12, 13, 14, 15, 16, 17, 18, 19, 20, 21, 22, 23, 24 or 25 kPa. Advantageously, the method may be repeated 2, 3, 4, 5, 6, 7, 8, 9 or 10 times.

In one embodiment, the apparatus comprises sealing means (such as a door, a flap, a plate, or a plug) disposed about the entry and/or exit ports, the sealing means configured to seal the main chamber against the ingress or egress of a gas. The provision of sealing means is typically for the purpose of maintaining a partial vacuum or partial pressure within the reaction chamber, or otherwise isolating an internal area of the reaction chamber from the atmosphere.

In one embodiment, the sealing means is/are preferably temporary doors capable of sealingly engaging with a surface surrounding the entry or exit port of the reaction chamber. The door may be bolted to the surrounding surface, with an optional compressible material disposed between a face of the door and the surrounding surface. The door may be fabricated from any material deemed suitable by the skilled person, and may be fabricated from a metal such as steel or aluminium.

The sealing means may be configured to be installable for testing and/or atmosphere conditioning of the reaction chamber and optionally easily removable for commencing processing of product intermediate once testing and/or conditioning is complete.

The sealing means may facilitate leakage testing of the reaction chamber, and in which case is configured to contain gas at a pressure of between about 1.5 kPa and about 20 kPa. Leakage testing using a vacuum at the equivalent negative pressures is also contemplated.

Where applications require pressurization of the reaction chamber, pressure or vacuum relief means (such as a valve, tap, or rupture disk) is included. Conveniently, the pressure or vacuum relief means may be incorporated into the sealing means.

The sealing means may facilitate conditioning of the reaction chamber atmosphere by allowing establishment of a partial vacuum (optionally between about −0.5 kPa and about −10 kPa) within the reaction chamber, and then introducing a desired gas (such as inert gas) or a gas mixture into the reaction chamber. Optionally, the gas mixture or gas mixture is introduced at a positive pressure (i.e. greater than atmospheric, and optionally between about 0.5 kPa and about 10 kPa).

In another embodiment, there is no vacuum established, however the desired gas or gas mixture us introduced at a positive pressure as described immediately supra.

The sealing means may also function in maintaining the integrity of the reaction chamber atmosphere during a cool down period, or when the reaction chamber is not in use by introducing an inert gas at a slight positive pressure into the reaction chamber. This maintains the integrity of the reaction chamber atmosphere for periods of inactivity.

The present apparatus may be otherwise configured to be useful in a carbon fibre precursor treatment method. As discussed elsewhere herein, temperature of particular reactions is important in so far as a failure to carefully control the temperature has an adverse effect on the process. In particular, the apparatus may be configured so as to minimise temperature variations within the reaction chamber, and/or a temperature differential from one end of a process gas recirculation circuit to the other, and/or a temperature differential from one end of the apparatus to the other. In prior art apparatus, process gas is recirculated and heated by a heater disposed within the return pathway of the recirculation circuit. Applicant proposes that temperature of the process gas drops from one end of the main recirculation path (i.e. the part of the recirculation circuit that contacts and heats the carbon fibre precursor) to an extent that consistent heating of the fibre is not possible.

Accordingly, in some embodiments the temperature of the carbon fibre precursor (and therefore also rate and/or extent of any chemical reaction within the fibre) is controlled by the present apparatus. Temperature variation in the process gas and/or the carbon fibre precursor may be maintained to within 0.1° C., 0.2° C., 0.3° C., 0.4° C., 0.5° C., 0.6° C., 0.7° C., 0.8° C., 0.9° C., 1.0° C., 1.1° C., 1.2° C., 1.3° C., 1.4° C., 1.5° C., 1.6° C., 1.7° C., 1.8° C., 1.9° C., 2.0° C., 2.1° C., 2.2° C., 2.3° C., 2.4° C., 2.5° C., 2.6° C., 2.7° C., 2.8° C., 2.9° C., 2.0° C., 2.1° C., 2.2° C., 2.3° C., 2.4° C., 2.5° C., 2.6° C., 2.7° C., 2.8° C., 2.9° C., 3.0° C., 3.1° C., 3.2° C., 3.3° C., 3.4° C., 3.5° C., 3.6° C., 3.7° C., 3.8° C., 3.9° C., 4.0° C., 4.1° C., 4.2° C., 4.3° C., 4.4° C., 4.5° C., 4.6° C., 4.7° C., 4.8° C., 4.9° C., or 5.0° C.

The temperature variation may be considered by reference to a point on a length of carbon fibre precursor as that point is conveyed from the entry port to the exit port of the reaction chamber. The temperature variation may be considered after the exclusion of any variation arising toward the entry port or exit port of the reaction chamber, give that these regions may be uncharacteristically cool, with reference to the temperature in the central region of the reaction chamber. In one embodiment, the temperature variation is considered over at least about 80%, 81%, 82%, 83%, 84%, 85%, 86%, 87%, 88%, 89%, 90%, 91%, 92%, 93%, 94%, 95%, 96%, 97%, 98%, 99% or about 100% of the residence time for the point on the length of a carbon fibre precursor under consideration.

The temperature variation may be considered by reference to the entire length of carbon fibre precursor within the reaction chamber at a single point in time. The temperature variation may be considered after the exclusion of any variation arising toward the entry port or exit port of the reaction chamber, give that these regions may be uncharacteristically cool, with reference to the temperature in the central region of the reaction chamber. In one embodiment, the temperature variation is considered over at least about 80%, 81%, 82%, 83%, 84%, 85%, 86%, 87%, 88%, 89%, 90%, 91%, 92%, 93%, 94%, 95%, 96%, 97%, 98%, 99% or about 100% of the residence time for the point on the length of a carbon fibre precursor under consideration.

Given the teachings of the present specification, the skilled person will be enabled to configure the present apparatus so as to obtain a desired minimum temperature variation within the reaction chamber. For example, the uniformity by which heated gas (such as the air bodies marked 20a and 20b in the drawings) surrounding the reaction chamber is heated may be increased by decreasing the spacing between electrical heating elements (such as those marked 40 in the drawing). The uniformity by which the heated gas is heated may be increased by increasing the level by which the gas is stirred. Increase in stirring may be achieved by decreasing the pacing between fans (such as those marked 45 in the drawings), or increasing the rate of rotation of the fans, or by increasing the rate or gas displacement of the fans, or by altering the pitch of the fan blades etc. Improving the efficiency of any insulation surrounding the external heated gas may also assist maintaining an even temperature through the heated gas.

A desired minimum temperature variation may be achieved by selecting appropriate material for construction of the muffle. For example, materials having a high thermal conductivity will act to rapidly dissipate any hot spots or cold spots so as to provide a more evenly heated muffle overall. By contrast, lower thermal conductivity material may take longer to transfer heat along the length of the muffle resulting in at least transient temperature variations. In embodiments of the invention having a divider within the muffle to separate the main process gas flow path from a return flow path, the divider may also be fabricated from a high thermal conductivity to improve heat transfer from the external heated gas to the return gas, and in turn to the main gas flow path.

The rate of process gas recirculation may also be adjusted so as to achieve a desired minimum temperature variation. However, given that the process gas actually contacts the carbon fibre precursor, there may exist some limitation between a process minimum (which may be required to remove an undesired by-product from the precursor, for example) and a process maximum (which may be required so as to limit turbulence in the gas, for example).

The present invention extends to methods of treating a carbon fibre precursor using any embodiment of the apparatus described herein. Where the method is for the treatment of a carbon fibre precursor, the method may require one or more of the following process parameters.

The apparatus may be configured so as to achieve a flow rate of process gas in the main flow path (i.e. the flow path which contacts the precursor) of about 0.4 ms⁻¹, 0.5 ms⁻¹, 0.6 ms⁻¹, 0.7 ms⁻¹, 0.8 ms⁻¹, 0.9 ms⁻¹, 1.0 ms⁻¹, 1.1 ms⁻¹, 1.2 ms⁻¹, 1.3 ms⁻¹, 1.4 ms⁻¹, 1.5 ms⁻¹, 1.6 ms⁻¹, 1.7 ms⁻¹, 1.8 ms⁻¹, 1.9 ms⁻¹, 2.0 ms⁻¹, 2.1 ms⁻¹, 2.2 ms⁻¹, 2.3 ms⁻¹, 2.4 ms⁻¹, 2.5 ms⁻¹, 2.6 ms⁻¹, 2.7 ms⁻¹, 2.8 ms⁻¹, 2.9 ms⁻¹, 3.0 ms⁻¹, 3.1 ms⁻¹, 3.2 ms⁻¹, 3.3 ms⁻¹, 3.4 ms⁻¹, 3.5 ms⁻¹, 3.6 ms⁻¹, 3.7 ms⁻¹, 3.8 ms⁻¹, 3.9 ms⁻¹, 4.0 ms⁻¹, 4.1 ms⁻¹, 4.2 ms⁻¹, 4.3 ms⁻¹, 4.4 ms⁻¹, 4.5 ms⁻¹, 4.6 ms⁻¹, 4.7 ms⁻¹, 4.8 ms⁻¹, 4.9 ms⁻¹, or 5.0 ms⁻¹,

In some embodiments, the apparatus is configured so as to provide regions of differing flow rate of process gas and/or differing temperatures of process gas. This allows for the establishment of differential conditions in the first half of the reaction chamber (i.e. from the entry port to the centre of the reaction chamber) and the second half of the reaction chamber (i.e. from the centre of the reaction chamber to the exit port). Methods of establishing differential conditions using an apparatus configured in this way are included within the scope of the present invention.

While the present invention has been described mainly in reference to the manufacture of carbon fibre, the present apparatus has broader applications. Any process requiring the establishment of a set temperature in a controlled gas environment may benefit from the present invention.

It will be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. Functionality may be added or deleted from diagrams and operations may be interchanged among functional blocks. Steps may be added or deleted to methods described within the scope of the present invention.

1. An apparatus for treating a carbon fibre precursor material, the apparatus comprising:
a housing, and
a reaction chamber disposed within the housing, the reaction chamber being elongate and having an entry port at a first end and an exit port at a second end, the entry and exit ports configured to allow passage of a carbon fibre precursor material into and out of the reaction chamber respectively and
a heater or heating system configured to heat a wall of the reaction chamber, wherein, in use, a precursor material is passed through the reaction chamber and is thereby heated.

2. The apparatus of claim 1, wherein the heater or heating system is disposed partially or completely external to the reaction chamber, partially internal to the reaction chamber, or partially or completely within a wall of the reaction chamber, or completely internal to the reaction chamber where another heater or another part of the heating system is disposed partially or completely external to the reaction chamber.

3. The apparatus of claim 1, wherein the housing is substantially thermally insulated.

4. The apparatus of claim 1, wherein the reaction chamber is suspended or supported within the housing such that the reaction chamber does not contact a floor or a ceiling of the reaction chamber.

5. The apparatus of claim 1, wherein the reaction chamber is a muffle.

6. The apparatus of claim 1 comprising:
a process gas source in fluid communication with the interior of the reaction chamber,
and
a process gas recirculation means configured to recirculate the process gas within the interior of the reaction chamber, heater or heating system,
wherein, in use, a carbon fibre precursor material is passed through the reaction chamber and the process gas recirculation means causes a substantially laminar flow of a heated process gas to contact the carbon fibre precursor material, and the heater or heating system regulates or stabilises the temperature of the process gas within the reaction chamber.

7. The apparatus of claim 1, wherein the heater or heating system heater or heating system is configured to provide a heated gas in contact with one or more external surfaces of the reaction chamber.

8. The apparatus of claim 1, wherein the housing is configured to retain a heated gas about one or more external surfaces of the reaction chamber.

9. (canceled)

10. (canceled)

11. The apparatus of claim 1, wherein the heater or heating system comprises a series of electrical heating elements disposed at intervals along the length of the apparatus.

12. The apparatus of claim 1, wherein the heater or heater system comprises heated gas stirring or recirculation means configured to stir a heated gas in contact with one or more external surfaces of the reaction chamber.

13. (canceled)

14. The apparatus of claim 12 comprising a series of heated gas stirring or recirculation means disposed at intervals along the length of the apparatus.

15. (canceled)

16. The apparatus of claim 6, configured such that the process gas is recirculated in opposing centre-to-end or end-to-end recirculation paths.

17. (canceled)

18. (canceled)

19. The apparatus of claim 16, wherein the opposing centre-to-end or end-to-end process gas recirculation system comprises a fan, and wherein the fan is disposed at or toward the end of the centre-to-end recirculation system, or at or toward the end of the end-to-end process gas recirculation system.

20. The apparatus of any one of claim 1, comprising process gas injection means configured to inject a process gas to the interior of the reaction chamber, wherein the process gas injection means is configured to inject the process gas at or about the process gas recirculation means.

21. The apparatus of claim 16 comprising a divider, the divider being disposed within the reaction chamber and running along the length thereof, so as to at least partially separate process gas in a return gas flow path from a main gas flow path.

22. The apparatus of claim 21, wherein the divider is part of a discrete duct, or forms a duct in combination with one or more interior surfaces of the reaction chamber.

23. The apparatus of claim 1, comprising carbon fibre precursor material transport means configured to transport a length of carbon fibre precursor material from the entry port to the exit port of the reaction chamber.

24. The apparatus of claim 1, comprising a pre-heater or having an associated pre-heater, the pre-heater being configured to increase the temperature of a material that is destined to enter the reaction chamber.

25. The apparatus of claim 8, comprising means for dividing the heated gas retained about the one or more external surfaces of the reaction chamber into two or more zones, wherein the apparatus is operable such that the temperature of a heated gas in a first zone is different to the temperature of a heated gas in a second zone.

26. The apparatus of claim 25, wherein the means for dividing the heated gas retained about the one or more external surfaces of the reaction chamber into two or more zones is a divider or a partial divider.

27. (canceled)
